(19) United States
(12) Patent Application Publication
(10) Pub. No.: US 2006/0293918 A1
(43) Pub. Date: Dec. 28, 2006

(54) Systems, methods and apparatus for cost analysis of medical devices

(75) Inventor: Patrick Barclay Dragani, Milwaukee, WI (US)

Correspondence Address: JAMES D IVEY, 3025 TOTTERDELL STREET, OAKLAND, CA, 94611-1742, US

(73) Assignee: General Electric Company, Schenectady, NY (US)

(21) Appl. No.: 11/166,695

(22) Filed: Jun. 25, 2005

(51) Int. Cl. G06Q 99/00; G06F 9/44; G06Q 10/00; G06F 19/00

(52) U.S. Cl. 705/2; 705/1; 700/108; 705/7

(57) ABSTRACT

Systems, methods and apparatus are provided through in some embodiments, the true cost of a medical device is determined by including in the cost a variety of costs such as maintenance and administrative costs associated with the medical device. In some embodiments, the true cost is included in a six-sigma improvement methodology to change the design of the medical device in order to reduce the cost of later manufactured medical devices.

### FIELD OF THE INVENTION

This invention relates generally to financial analysis of manufactured medical devices, and more particularly to determining cost of medical imaging devices.

### BACKGROUND OF THE INVENTION

In the healthcare industry, healthcare costs have been increasing primarily due to demographic changes in the population that require increasing amounts of healthcare for an aging population. The increasing financial burden on employers and individuals who pay for the healthcare costs and healthcare insurance premiums have prompted the payors to pressure healthcare providers to lower their costs. In some instances, the amount of money paid to healthcare practitioners, such as general practitioners, has been reduced.

The price pressure has rippled through the healthcare industry to the manufacturers of medical devices. The healthcare practitioners have in turn pressured their suppliers for reductions in prices. For example, the manufacturers of medical device have been strongly encouraged by healthcare facilities and health insurance carriers to lower their prices.

Accordingly, in the manufacture of medical device, cost control is increasingly an important issue. The medical device manufacturers search diligently for ways and means to reduce their cost structure. One means of reducing their costs is to reduce the cost of goods sold. However, the actual cost of goods sold is not known with complete accuracy. Suspicions abound that some cost in the manufacture of medical imaging device is not known.

In particular, medical imaging device manufacturers struggle to measure the effect of quality problems in components of the medical imaging devices. The medical imaging device manufacturers struggle to understand how much of their cost structure comes from fixing and attending to quality problems and defects.

For the reasons stated above, and for other reasons stated below which will become apparent to those skilled in the art upon reading and understanding the present specification, there is a need in the art for improved analysis of the cost of medical imaging devices. There is also a need for improved understanding of the effect of quality deficiencies in the manufacture of the medical imaging devices.

### BRIEF DESCRIPTION OF THE INVENTION

The above-mentioned shortcomings, disadvantages and problems are addressed herein, which will be understood by reading and studying the following specification.

In one aspect, a method to improve cost of a component of a medical imaging device includes measuring cost of quality of the component and reducing the cost of quality from a six-sigma improvement methodology. This method is referred to as Six Sigma Cost of Quality methodology. In some examples, the Six Sigma Cost of Quality methodology provides a calculation of the cost of events that occur after occurrence of a quality problem or the Six Sigma Cost of Quality methodology provides a calculation of the amount of time taken to prevent a quality problem. The methodology helps companies focus resources, dollars, and specific actions towards quality issues that are currently affecting their businesses.

In another aspect, a method to analyze cost of a component of a medical imaging device includes determining purchase cost of the component and adding all consequential costs of quality deficiencies to the purchase cost, yielding a true cost index.

In yet another aspect, a system to focus resources, funds and actions towards quality problems, includes a processor, a storage device coupled to the processor, the storage device including a cost model of a medical imaging device including a cost of a quality deficiency and a number of occurrences of the quality deficiency. The system further includes software apparatus operative on the processor for determining a true cost index by multiplying the number of occurrences by the cost and summarizing graphically the true cost index.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram that provides an overview of a system to focus resources, funds and actions towards quality problems in medical devices;

FIG. 2 is a flowchart of a method to reduce cost of components in a medical device according to an embodiment;

FIG. 3 is a flowchart of a method of additional actions to FIG. 2 to reduce cost of components in a medical device according to an embodiment;

FIG. 4 is a flowchart of a method of measuring a cost of quality of a component, according to an embodiment;

FIG. 5 is a flowchart of a method to determine a true cost of a component of a medical device according to an embodiment;

FIG. 6 is a block diagram of an example of a conventional medical imaging device;

FIG. 7 is a block diagram of a hierarchy of components of a medical device; and

FIG. 8 is a block diagram of the hardware and operating environment in which different embodiments can be practiced.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, a system level overview is described. In the second section, methods of embodiments are described. In the third section, medical device components are described. In the fourth section, the hardware and the operating environment in conjunction with which embodiments may be practiced are described. Finally, in the fifth section, a conclusion of the detailed description is provided.

### System Level Overview

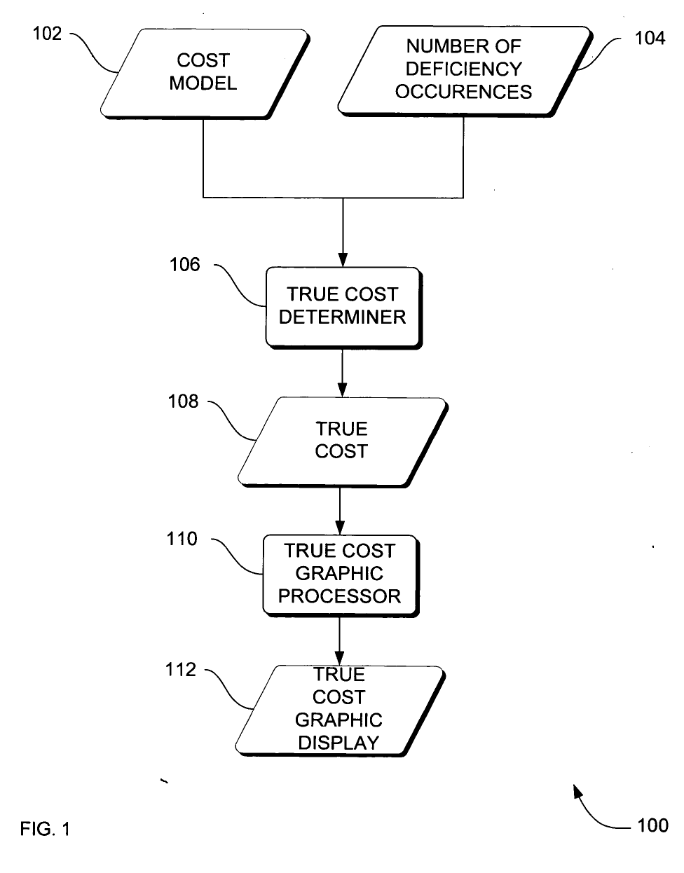

FIG. 1 is a block diagram that provides an overview of a system to focus resources, funds and actions towards quality problems in medical devices. System 100 solves the need in the art to improve analysis of the cost of a medical device. System 100 also solves the need in the art to improve understanding of the effect of quality deficiencies in the manufacture of the medical devices.

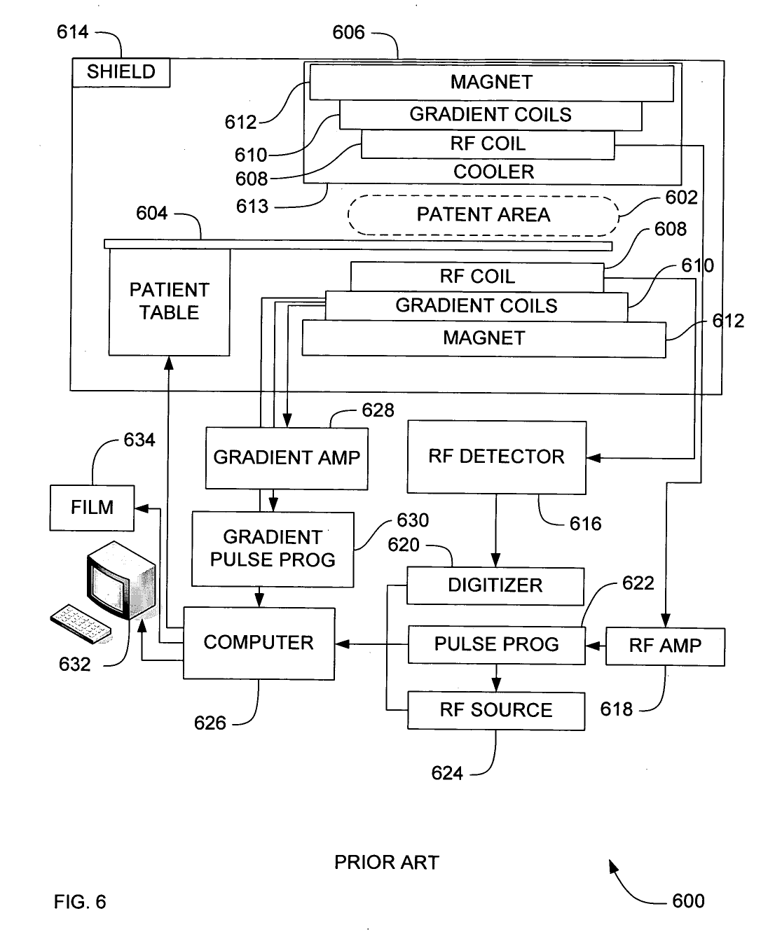

System 100 includes a cost model 102 of the medical device. One example of a medical imaging device is shown in FIG. 6 below. The cost model includes an indication of at least one cost of a quality deficiency, which is often referred to a “cost of quality” or a “quality cost.” A cost of quality is an expense that is borne in conforming a component to a specified level of quality. Examples of cost of quality include the cost of purchasing or manufacturing the component, the administrative cost of procuring the component, the cost of inspecting the component, the cost of replacing, reworking, repairing and/or fixing the component before or after integrating the component into the medical device, and the cost of determining, storing and reporting status, condition or history of the component to regulatory agencies. The cost can include all labor, such as direct labor, administrative support and/or management of the above processes. The cost can also include preventive and routine maintenance measures in reducing the risk of failure of the component.

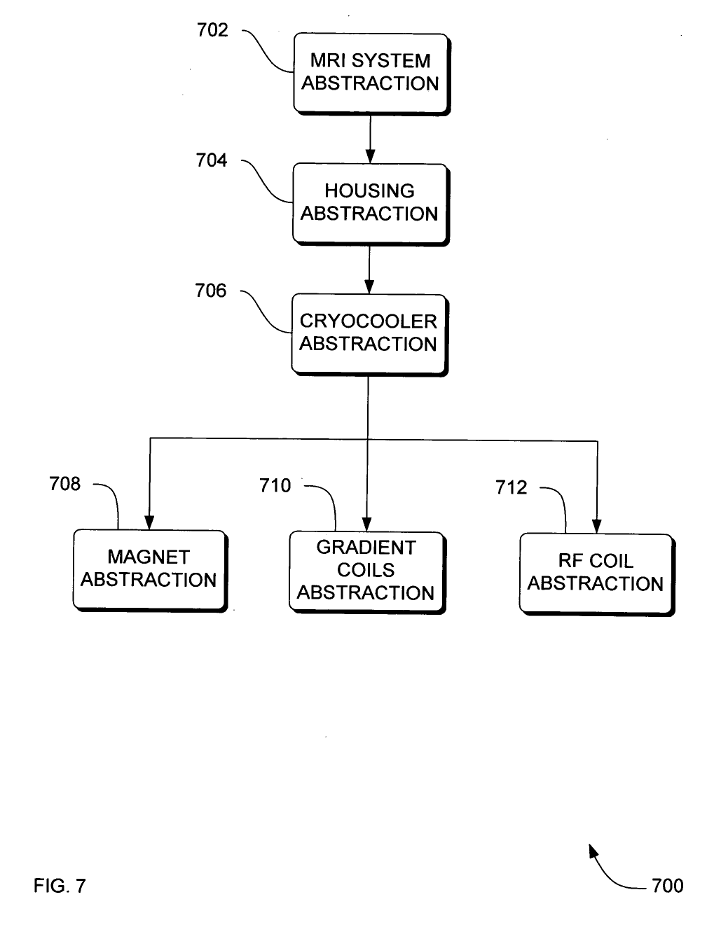

In some embodiments, the cost model 102 includes a description or model of a plurality of components that are associated to each other in a hierarchy in a medical device. One embodiment of a hierarchy of components of a medical device is shown in FIG. 7 below.

System 100 also includes an indication of the number of occurrences 104 of the quality deficiency.

A determiner 106 of a true cost of the component multiplies the cost of quality deficiency from the cost model 102 with the number of occurrences 104 of the quality deficiency. The true cost 108 is also referred to as a true cost index.

A true cost graphic processor 110 generates a graphic display 112 of the true cost 108. In some embodiments the true cost is communicated in a non-graphic format. The true cost is information that can be used to improve analysis of the cost of medical devices and to improve understanding of the effect of quality deficiencies in the manufacture of the medical devices

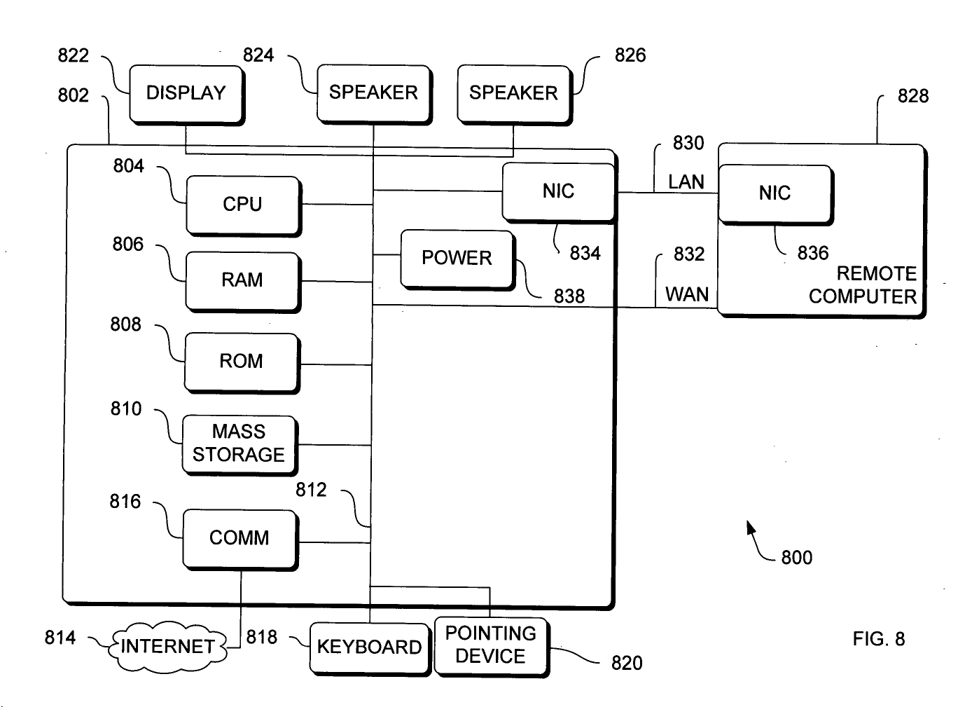

The system level overview of the operation of an embodiment is described in this section of the detailed description. The true cost of a component of a medical device is determined by system 100. Some embodiments of system 100 operate in a multi-processing, multi-threaded operating environment on a computer, such as computer 802 in FIG. 8.

While the system 100 is not limited to any particular medical equipment or device, cost model 102, number of occurrences 104, determiner 106 of a true cost 108, true cost graphic processor 110, or graphic display 112 of the true cost, for sake of clarity, a simplified medical device, cost model 102, number of occurrences 104, determiner 106 of a true cost 108, true cost graphic processor 110, graphic display 112 of the true cost are described.

### Methods of an Embodiment

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-500 are performed by a program executing on, or performed by firmware or hardware that is a part of, a computer, such as computer 802 in FIG. 8.

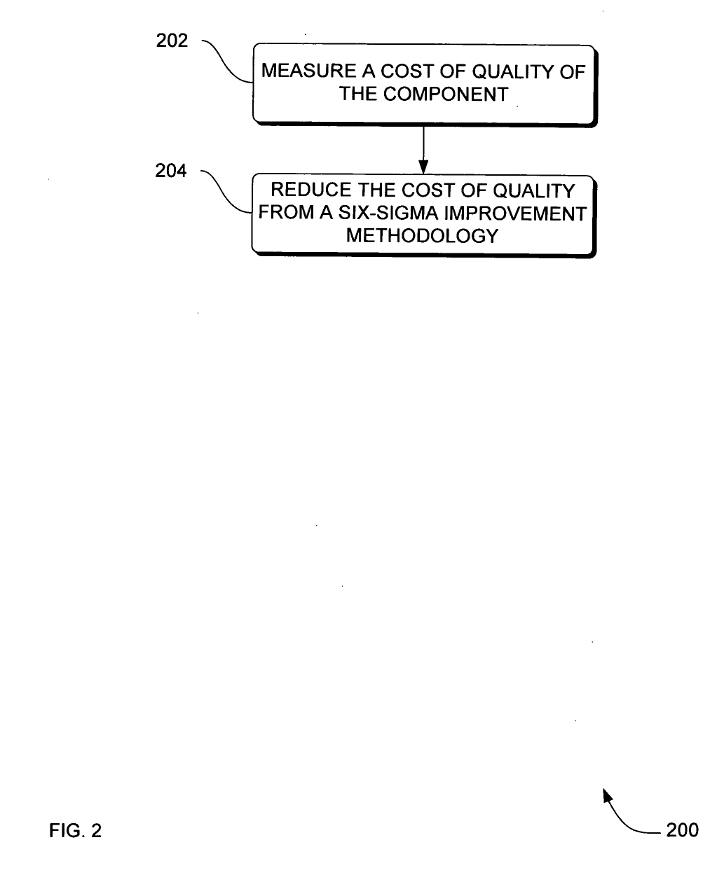

FIG. 2 is a flowchart of a method 200 to reduce cost of components in a medical device according to an embodiment. Method 200 solves the need in the art to reduce cost of a component of a medical device.

Method 200 includes measuring 202 a cost of quality of the component. Thereafter, method 200 includes reducing 204 the cost of quality from a six-sigma improvement methodology.

Six Sigma is a disciplined, data-driven approach and methodology for eliminating defects (driving towards six standard deviations between the mean and the nearest specification limit) in any process—from manufacturing to transactional and from product to service.

The statistical representation of Six Sigma describes quantitatively how a process is performing. To achieve Six Sigma, a process must not produce more than 3.4 defects per million opportunities. A Six Sigma defect is defined as anything outside of customer specifications. A Six Sigma opportunity is then the total quantity of chances for a defect. Process sigma can easily be calculated using a Six Sigma calculator.

The fundamental objective of the Six Sigma methodology is the implementation of a measurement-based strategy that focuses on process improvement and variation reduction through the application of Six Sigma improvement projects. This is accomplished through the use of two Six Sigma sub-methodologies: DMAIC and DMADV. The Six Sigma DMAIC process (define, measure, analyze, improve, control) is an improvement system for existing processes falling below specification and looking for incremental improvement. The Six Sigma DMADV process (define, measure, analyze, design, verify) is an improvement system used to develop new processes or products at Six Sigma quality levels. It can also be employed if a current process requires more than just incremental improvement.

In some embodiments, the component is one of a plurality of components of the medical device that are associated to each other in a hierarchy. The method 200 of cost reduction is performed for the plurality of components of the medical imaging device. In some embodiments the plurality of components of the medical device encompasses all components of the medical device. One embodiment of a hierarchy of plurality of components of a medical device is shown in FIG. 6 below. The hierarchy can be used to summarize data for each record or roll up a set of specific records when required to create custom reporting at many different levels.

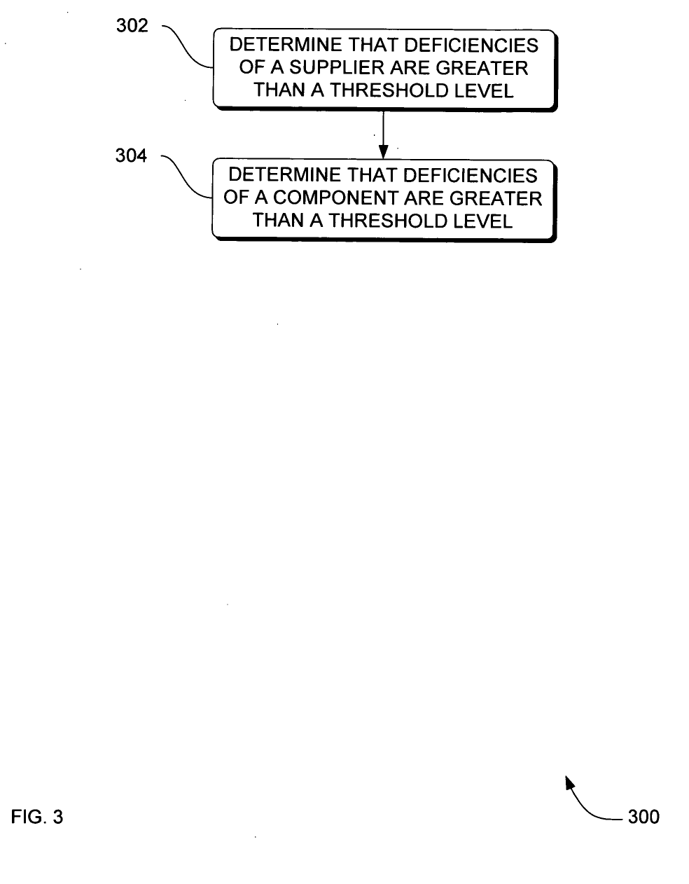

FIG. 3 is a flowchart of a method 300 of additional actions to method 200 to reduce cost of components in a medical device according to an embodiment. Method 300 solves the need in the art to reduce cost of a component of a medical device.

In some embodiments, method 300 includes determining 302 that the cost of quality or deficiencies associated with a supplier is beyond a threshold level or extent. In action 302, components are identified by a serial identification and an associated supplier identification. The extent of deficiencies associated with a supplier are traced to or associated with the supplier through the serial identification of components are reported as having some sort of quality deficiency.

In some embodiments, method 300 also includes determining 304 that the cost of quality or deficiencies of a component is beyond a threshold extent or level.

In method 300, in some examples the threshold level or extent in action 302 and/or action 304 is a maximum acceptable level beyond which more or the same components can be accepted from the supplier. In other examples, the threshold is a level beyond which more of the same components will be accepted from the supplier but where the cost of quality is high enough where other components or suppliers might substituted at a lower cost of quality. Threshold level in expressed in some embodiments as a portion or percentage of the purchase cost of the medical imaging equipment, in which the relative incremental, additional, marginal, “delta” cost of quality of the component is evaluated. Threshold level in expressed in some embodiments as an absolute monetary amount in comparison to the purchase cost of the medical imaging equipment, in which the absolute incremental, additional, marginal, “delta” cost of quality of the component is evaluated.

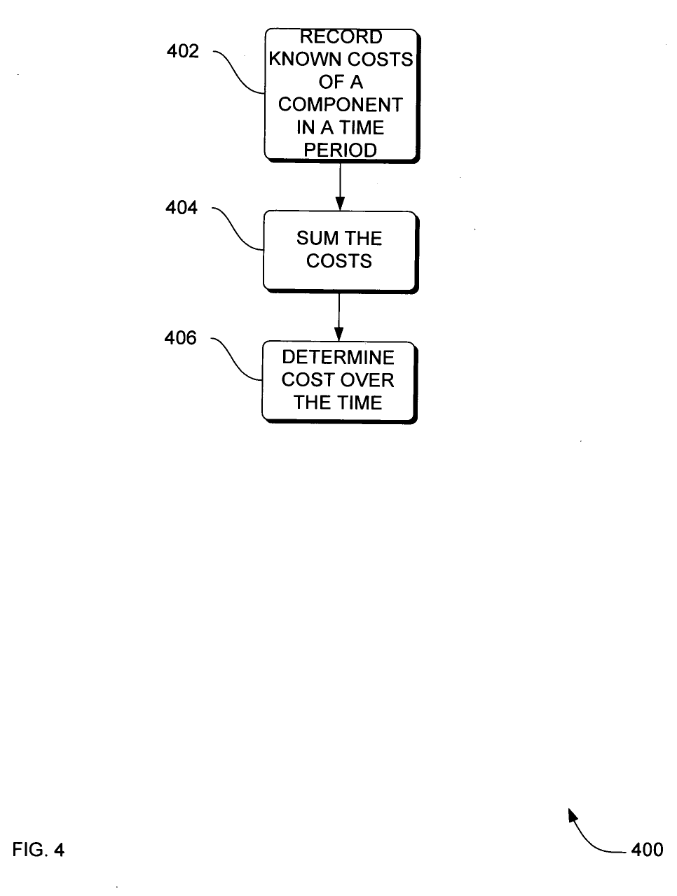

FIG. 4 is a flowchart of a method 400 of measuring a cost of quality of a component, according to an embodiment. Method 400 is one embodiment of measuring 202 a cost of quality of the component in FIG. 2. Method 400 solves the need in the art to reduce cost of a component of a medical device.

Method 400 includes recording 402 all known costs associated with all instances of the component within a time period and summing 404 the known costs. Cost of the component in relation to the time period is determined 406 in one of a number of processes such as by dividing the summed known costs by the number of the instances during the time period, or amortizing the known costs to the beginning of the time period.

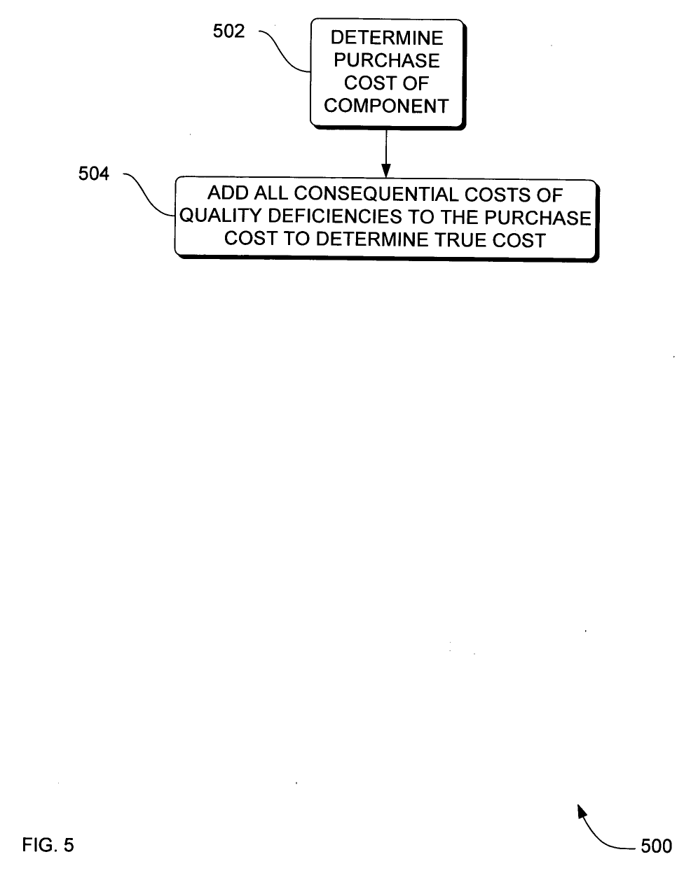

FIG. 5 is a flowchart of a method 500 to determine a true cost of a component of a medical device according to an embodiment. Method 500 solves the need in the art to analyze cost of a component of a medical imaging device.

Method 500 includes determining 502 a purchase cost of the component. Method 500 also includes adding 504 all consequential costs of quality deficiencies to the purchase cost, yielding a true cost index.

In some embodiments, the component is one of a plurality of components of the medical device that are associated to each other in a hierarchy. The method 200 of cost reduction is performed for the plurality of components of the medical imaging device. In some embodiments the plurality of components of the medical device encompasses all components of the medical device. One embodiment of a hierarchy of plurality of components of a medical device is shown in FIG. 7 below.

In some embodiments, methods 200-500 are implemented as a computer data signal embodied in a carrier wave, that represents a sequence of instructions which, when executed by a processor, such as processor 804 in FIG. 8, cause the processor to perform the respective method. In other embodiments, methods 200-500 are implemented as a computer-accessible medium having executable instructions capable of directing a processor, such as processor 804 in FIG. 8, to perform the respective method. In varying embodiments, the medium is a magnetic medium, an electronic medium, or an optical medium.

Apparatus 100 components and methods 200-500 can be embodied as computer hardware circuitry or as a computer-readable program, or a combination of both. In another embodiment, system 100 or methods 200-500 are implemented in an application service provider (ASP) system.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 802 in FIG. 8, or on at least as many computers as there are components.

### Medical Device Components

FIG. 6 is a block diagram of an example of a conventional medical imaging device 600. The imaging device 600 is a magnetic resonance imaging system (MRI) that uses perturbations in strong magnetic fields to detect structure of an object. Imaging device 600 creates images of a medical patient (not shown) positioned in a patient area 602 on patient table 604. A housing 606 includes a cylindrical RF coil 608 that is surrounded by cylindrical coils 610, which is in turn surrounded by a cylindrical magnet 612. The cylindrical RF coil 608 that is surrounded by cylindrical gradient coils 610, which is in turn surrounded by a cylindrical magnet 612. The RF coil 608, gradient coils 610 and the magnet 612 are encased in a cryocooler 613 of liquid helium that cools the components to a superconducting temperature. The housing 606 also includes a shield 614.

The RF coil 608 transmits analog signals to a radio frequency (RF) detector 616 and an RF amplifier (amp) 618. The RF detector 616 sends analog signals to a digitizer 620. The RF amp 618 sends analog signals to a pulse program 622. The pulse program 622 sends signals to a RF source 624. The digitizer 620, the pulse program 622 and the RF source 624 send signals to a computer 626.

The gradient coils 610 transmit electrical signals to a gradient amplifier 628. The gradient coils 610 and the gradient amp 628 send signals to a gradient pulse program 630. The gradient pulse program 630 transmits signals to the computer 626. The computer 626 sends signals to a terminal 632, a film imager 634 and the patient table 604. An image of the structure of the patient's body is generated by the film imager 634.

FIG. 7 is a block diagram of a hierarchy 700 of components of a medical device. More specifically, hierarchy 700 is a hierarchy of some components in a MRI system.

At the highest level, hierarchy 700 includes an abstraction of the MRI system 702. Below the MRI system abstraction 702 is an abstraction of a housing 704. Below the housing abstraction 702 is an abstraction of a cryocooler 706. Below the cryocooler abstraction 706 is an abstraction of a magnet 708, an abstraction of a plurality of gradient coils 710 and an abstraction of an RF coil 712.

### Hardware and Operating Environment

FIG. 8 is a block diagram of the hardware and operating environment 800 in which different embodiments can be practiced. The description of FIG. 8 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 802 includes a processor 804, commercially available from Intel, Motorola, Cyrix and others. Computer 802 also includes random-access memory (RAM) 806, read-only memory (ROM) 808, and one or more mass storage devices 810, and a system bus 812, that operatively couples various system components to the processing unit 804. The memory 806, 808, and mass storage devices, 810, are types of computer-accessible media. Mass storage devices 810 are more specifically types of nonvolatile computer-accessible media and can include one or more hard disk drives, floppy disk drives, optical disk drives, and tape cartridge drives. The processor 804 executes computer programs stored on the computer-accessible media.

Computer 802 can be communicatively connected to the Internet 814 via a communication device 816. Internet 814 connectivity is well known within the art. In one embodiment, a communication device 816 is a modem that responds to communication drivers to connect to the Internet via what is known in the art as a “dial-up connection.” In another embodiment, a communication device 816 is an Ethernet® or similar hardware network card connected to a local-area network (LAN) that itself is connected to the Internet via what is known in the art as a “direct connection” (e.g., T1 line, etc.).

A user enters commands and information into the computer 802 through input devices such as a keyboard 818 or a pointing device 820. The keyboard 818 permits entry of textual information into computer 802, as known within the art, and embodiments are not limited to any particular type of keyboard. Pointing device 820 permits the control of the screen pointer provided by a graphical user interface (GUI) of operating systems such as versions of Microsoft Windows®. Embodiments are not limited to any particular pointing device 820. Such pointing devices include mice, touch pads, trackballs, remote controls and point sticks. Other input devices (not shown) can include a microphone, joystick, game pad, satellite dish, scanner, or the like.

In some embodiments, computer 802 is operatively coupled to a display device 822. Display device 822 is connected to the system bus 812. Display device 822 permits the display of information, including computer, video and other information, for viewing by a user of the computer. Embodiments are not limited to any particular display device 822. Such display devices include cathode ray tube (CRT) displays (monitors), as well as flat panel displays such as liquid crystal displays (LCD's). In addition to a monitor, computers typically include other peripheral input/output devices such as printers (not shown). Speakers 824 and 826 provide audio output of signals. Speakers 824 and 826 are also connected to the system bus 812.

Computer 802 also includes an operating system (not shown) that is stored on the computer-accessible media RAM 806, ROM 808, and mass storage device 810, and is and executed by the processor 804. Examples of operating systems include Microsoft Windows®, Apple MacOS®, Linux®, UNIX®. Examples are not limited to any particular operating system, however, and the construction and use of such operating systems are well known within the art.

Embodiments of computer 802 are not limited to any type of computer 802. In varying embodiments, computer 802 comprises a PC-compatible computer, a MacOS®-compatible computer, a Linux®-compatible computer, or a UNIX®-compatible computer. The construction and operation of such computers are well known within the art.

Computer 802 can be operated using at least one operating system to provide a graphical user interface (GUI) including a user-controllable pointer. Computer 802 can have at least one web browser application program executing within at least one operating system, to permit users of computer 802 to access an intranet, extranet or Internet world-wide-web pages as addressed by Universal Resource Locator (URL) addresses. Examples of browser application programs include Netscape Navigator® and Microsoft Internet Explorer®.

The computer 802 can operate in a networked environment using logical connections to one or more remote computers, such as remote computer 828. These logical connections are achieved by a communication device coupled to, or a part of, the computer 802. Embodiments are not limited to a particular type of communications device. The remote computer 828 can be another computer, a server, a router, a network PC, a client, a peer device or other common network node. The logical connections depicted in FIG. 8 include a local-area network (LAN) 830 and a wide-area network (WAN) 832. Such networking environments are commonplace in offices, enterprise-wide computer networks, intranets, extranets and the Internet.

When used in a LAN-networking environment, the computer 802 and remote computer 828 are connected to the local network 830 through network interfaces or adapters 834, which is one type of communications device 816. Remote computer 828 also includes a network device 836. When used in a conventional WAN-networking environment, the computer 802 and remote computer 828 communicate with a WAN 832 through modems (not shown). The modem, which can be internal or external, is connected to the system bus 812. In a networked environment, program modules depicted relative to the computer 802, or portions thereof, can be stored in the remote computer 828.

Computer 802 also includes power supply 838. Each power supply can be a battery.

### CONCLUSION

A true cost index calculator for medical devices is described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application meant to include all object-oriented, database and communication environments and alternate technologies which provide the same functionality as described herein.

I claim:

1. A computer-accessible medium having executable instructions to improve cost of a component of a medical imaging device, the executable instructions capable of directing a processor to perform:
measuring cost of quality of the component; and
reducing the cost of quality from a six-sigma improvement methodology.

2. The computer-accessible medium of claim 1, the medium further comprising executable instructions capable of directing a processor to perform the executable instructions for a plurality of components of the medical imaging device.

3. The computer-accessible medium of claim 2, wherein the plurality of components further comprises:
all of the components in the medical imaging device.

4. The computer-accessible medium of claim 1, wherein the component is identified by a serial identification and a supplier identification and the medium further comprising executable instructions capable of directing a processor to perform:
determining that deficiencies associated with the supplier is beyond a threshold;

5. The computer-accessible medium of claim 1, the medium further comprising executable instructions capable of directing a processor to perform:
determining that the cost of quality of the component is beyond a threshold extent.

6. The computer-accessible medium of claim 5, the threshold extent further comprises:
a portion of the cost of the medical imaging devices.

7. The computer-accessible medium of claim 5, the threshold extent further comprises:
an absolute monetary amount.

8. The computer-accessible medium of claim 1, wherein the measuring further comprises:
recording all known costs associated with all instances of the component within a time period;
summing the known costs; and
determining the average cost of the component by dividing the summed known costs by the number of the instances.

9. The computer-accessible medium of claim 8, wherein determining the average cost further comprises:
amortizing the known costs to the beginning of the time period.

10. The computer-accessible medium of claim 8, wherein all known costs further comprise:
a procurement cost of obtaining a replacement component for a defective component; and
an installation cost to install the replacement component.

11. The computer-accessible medium of claim 8, wherein all known costs further comprise:
a cost of prevention of a deficiency.

12. A computer-accessible medium having executable instructions to analyze cost of a component of a medical imaging device, the executable instructions capable of directing a processor to perform:
determining purchase cost of the component; and
adding all consequential costs of quality deficiencies to the purchase cost, yielding a true cost index.

13. The computer-accessible medium of claim 12, the medium further comprising executable instructions capable of directing a processor to perform the executable instructions for a plurality of components of the medical imaging device.

14. The computer-accessible medium of claim 12, wherein the plurality of components further comprise:
a plurality of components that are associated to each other in a hierarchy.

15. The computer-accessible medium of claim 12, wherein the plurality of components further comprise:
all of the components in the medical imaging device.

16. A system to focus resources, funds and actions towards quality problems, the system comprising:
a processor;
a storage device coupled to the processor, the storage device further comprising”
a cost model of a medical imaging device including a cost of a quality deficiency; and
a number of occurrences of the quality deficiency, and
software apparatus operative on the processor for:
determining a true cost index by multiplying the number of occurrences by the cost; and
summarizing graphically the true cost index.

17. The system of claim 16, wherein the cost model further comprises:
a cost model of a plurality of components of the medical imaging device; wherein the plurality of components are associated to each other in a hierarchy.

18. A method to improve cost of a component of a medical imaging device, the executable instructions capable of directing a processor to perform:
measuring cost of quality of the component;
determining that deficiencies associated with the supplier is beyond a threshold;
reducing the cost of quality from a six-sigma improvement methodology;
recording all known costs associated with all instances of the component within a time period;
summing the known costs; and
determining the average cost of the component by dividing the summed known costs by the number of the instances.

19. The method of claim 18, the medium further comprising executable instructions capable of directing a processor to perform the executable instructions for all of the components in the medical imaging device.

20. The method of claim 18, wherein determining the average cost further comprises:
amortizing the known costs to the beginning of the time period, and
wherein all known costs further comprise:
a procurement cost of obtaining a replacement component for a defective component;
an installation cost to install the replacement component; and
a cost of prevention of a deficiency.
